(19) United States
(12) Patent Application Publication
(10) Pub. No.: US 2021/0147256 A1
(43) Pub. Date: May 20, 2021

(54) SELF CONTAINED, AUTOMATIC WATER QUALITY MONITORING AND TREATMENT SYSTEM

(71) Applicant: FLUID HANDLING LLC., Morton Grove, IL (US)

(72) Inventors: Kyle D. SCHOENHEIT, Waterloo, NY (US); Matthew J. RUFFO, Geneva, NY (US); Michael A. SUTTON, The Woodlands, TX (US)

(21) Appl. No.: 17/099,269

(22) Filed: Nov. 16, 2020

Related U.S. Application Data
(63) Continuation of application No. 14/627,181, filed on Feb. 20, 2015, now abandoned.
(60) Provisional application No. 61/942,419, filed on Feb. 20, 2014.

(51) Int. Cl. C02F 1/00

(52) U.S. Cl. CPC C02F 1/008; C02F 2209/04; C02F 2209/06; C02F 2209/006; C02F 2209/29; C02F 2209/008; C02F 2209/15; C02F 2209/055; C02F 2209/24; C02F 2209/26; C02F 2209/22

(57) ABSTRACT

A self contained, automatic water quality monitoring and treatment system includes a water quality interface control module having a signal processor configured to: receive signaling containing information about a baseline test of pH and ORP levels of water to be monitored and also about a subsequent test of the pH and ORP levels of water to be monitored later in time to the baseline test; determine corresponding signaling containing information about the quality of the water being monitored based upon a percentage of change between the baseline test and the subsequent test later in time to the baseline of the pH and ORP levels of water being monitored; and provide the corresponding signaling for remote awareness, including wireless signaling for providing mobile or Internet awareness, and/or for controlling the treatment of the water being monitored.

### CROSS-REFERENCE TO RELATED APPLICATION

This application claims benefit to provisional patent application Ser. No. 61/942,419, filed 20 Feb. 2014, which is hereby incorporated by reference in its entirety.

### BACKGROUND OF THE INVENTION

### 1. Field of the Invention

The present invention relates to a water treatment system; and more particularly relates to a water treatment system for providing remote, mobile or Internet awareness of the quality of water being monitored.

### 2. Brief Description of Related Art

The market has many commercially available devices capable of measuring pH and oxidation levels for contained water, for uses in applications such as aquariums and/or aquaculture. These devices measure pH and oxidation levels and manual thresholds can be defined by the user. The user then manually adjusts the quality of the water.

The shortcoming of what is currently commercially available is the scientific operation and set-up of the device, namely the thresholds are defined by units of measurement (pH scale or mV etc.) of which the typical household consumer is not aware. Based on this, the user must then make changes to adjust water quality manually, which entails contact with water treatment chemicals.

By way of example, known commercially available products include Milwaukee Instruments pH & ORP Controller, MC125, having a professional pH/ORP controller that is characterized by the following:
User selectable hi/low set point;
Manual 2 point calibration;
Visual LED Alarm: Active when reading is higher or lower than the user selectable set point;
12 VDC adapter and mounting kit included; and
Typical use or promoted use—Aquarium applications.

There is a need in the industry for a product that provides a better way of measuring pH and oxidation (ORP) levels for contained water by a user.

### SUMMARY OF THE INVENTION

In summary, the present invention provides a new and unique self contained, automatic water quality monitoring and treatment system or technique having one or more of the following features:

Packaging a measuring device into an awareness based “percentage of change” unit, which could be displayed in a visual rate of change (i.e., relative) vs. discrete measurement;

Alarm awareness monitoring may be, but not limited to, wireless for mobile or internet awareness;

Utilizing remote display units to be placed at convenient areas to alert the user of water quality issues;

Adding module component to the overall device that could automatically adjust water treatment appliance(s), e. g., a chlorinator, water softener, etc.;

Displaying of “water health/water quality” would be relative to quality of lab tested water sample as baseline; remote awareness (e.g., via LAN, Wired, Internet/mobile monitoring, etc.) and would have a positive emotional effect as well as the device would respond to “poor water quality” if integrated with water conditioning appliances and/or treatment modules that could receive response from the measuring device.

### The System

By way of example, and according to the present invention, the basic system may include two basic components, including a monitoring section and a treatment section.

### The Monitoring Section

The monitoring or control unit or section may include, or take the form of, some combination of a Water Quality Interface Control Module (WQICM), an output module, and a signal response for water treatment controller. By way of example, the WQICM may be installed in a basement or other area of a building, e.g., in-line with incoming water lines to the building. The WQICM may be configured with a user interface for providing settings that would be provided by a user, as well as a display for displaying the quality of the water being monitored. The user would provide setting via the user interface, which may include a pre-set percentage of change or rate in order to monitor the water quality and, if chosen, an alert setting by which the user through one or more remotely mounted display units or user interfaces may be informed of the alert. Whether the remote user interfaces are utilized or not, the WQICM may activate an automatic in-line water treatment module, e.g., via the signal response for water treatment controller, which may apply one or more treatments to the incoming water. The automatic in-line water treatment module may be configured to provide, and the WQICM may be configured to receive, a status signal containing information about the status of one or more tanks containing one or more treatment materials, and alerts the user when the treatment tanks are low or empty.

By way of example, the pH vs. ORP may be measured, as follows:
Create baseline water test (e.g., using 3^{rd} party such as a lab test) at initial installation of device, e.g., using the WQICM;
Test results to define initial water quality acceptance, water treatment may be needed; and
Installation of the pH sensor and ORP sensor modules to capture the sensed water measurements and process the signaling associated with the same.

### Response of System

By way of example, the response of the system may include the following:

In operation, the pH vs. ORP would measure change (delta), which may be used consistent with the following:
Response to relative percentage of change (i.e. a visual bar graph); this differs from the prior art commercially available devices in which the user would be required to define limits;
Response to a change in the water quality would also signal a “water treatment” device to increase/decrease treatment, e.g., via the provisioning of corresponding signaling using the output module and/or the signal response for water treatment controller.
   This would meter the water treatment of “poor” water quality in terms of actual need instead of consistent treatment which may lead to overtreatment or under treatment.
   The Environment Protection Agency (EPA) suggests to test water at least every year for total coliform bacteria, nitrates, total dissolved solids and pH levels, e.g., especially if one has a new well, or have replaced or repaired pipes, pumps or the well casing.
Typical Water Quality Occurrences: Table 1 is provided below and shows examples of typical water quality occurrences.
Response of water quality “change” may also be accessible via one or more web-based applications, e.g., using wireless signaling integrated into the measuring device, etc.

### The Treatment Section

The treatment section may be implemented, as follows:

The treatment section may include an in-line water sensing module and the in-line water treatment module.

The in-line water sensing module may contains sensors to measure and analyze the water quality. The water may be analyzed and the results may be transmitted back to the WQICM for implementing treatment action.

The in-line water treatment module may include inputs for receiving treatment signaling from the signal response for water treatment controller and inputs from various materials for treatment. Once the WQICM reviews the results of the monitoring, the corresponding signal may be sent out via the signal response module to the in-line water treatment module and the proper treatment materials may be administered to the water as specified by the settings on the WQICM.

### The Signal Processing Based Embodiments

According to some embodiments, the present invention may be implemented in the form of apparatus, e.g., featuring a signal processor configured at least to:
receive signaling containing information about a baseline test of pH and oxidation levels of water to be monitored and also about a subsequent test of the pH and oxidation levels of water to be monitored later in time to the baseline test; and
determine corresponding signaling containing information about the quality of the water being monitored based upon a percentage of change between the baseline test and the subsequent test later in time to the baseline of the pH and oxidation levels of water being monitored.

The signal processor may also be configured to provide the corresponding signaling for remote awareness, including via wireless signaling, either for displaying on a display of a remote user interface the percentage of change between the baseline test and the subsequent test, or controlling the treatment of the water being monitored, or both.

According to some embodiment of the present invention, the apparatus may also include one or more of the following features:

The baseline test may be based upon lab tested water (e.g., by a third party), or may be conducted at an initial installation, e.g., by the system according to the present invention.

The signal processor may be configured to make the determination at a pre-set rate, including where the pre-set rate is either a user-defined pre-set rate or is a factory pre-set rate.

The apparatus may include, or take the form of, an awareness-based “percentage of change” unit, e.g., having the signal processor in combination with a display configured to provide a visual rate of percentage change indication versus a discrete measurement, or an alert module for providing an audio or visual alert based upon an alert setting, or both the display and the alert module.

The apparatus may include one or more remote user interfaces or display units, e.g., having a corresponding signal processor in combination with a display, the corresponding signal processor configured to receive the corresponding signaling, and the display configured to display a visual rate of percentage change indication versus a discrete measurement, based upon the corresponding signaling received.

The apparatus may include an in-line sensing module, e.g., having one or more in-line sensors configured to sense the pH and oxidation (e.g., ORP) levels of water to be monitored as part of the baseline test or the subsequent test, and provide sensed signaling containing information about the pH and ORP levels of water to be monitored, including where the sensed signaling is provided to a signal response module for a water treatment controller.

The apparatus may include an in-line water treatment module configured to receive the water being monitored; and the in-line water treatment module may include one or more treatment input control modules configured to receive the corresponding signaling in the form of treatment signaling, and provide treatment material to the in-line water treatment module to change the quality of water, e.g., including where the treatment material changes the pH and ORP levels of water by adjusting the chlorination or softness of the water being monitored.

The awareness-based “percentage of change” unit may be configured to react to changes in contaminants in the water, including primary contaminants that take the form of iron, alkaline or acid reactives (pH), chlorine or nitrates. The awareness-based “percentage of change” unit may be also configured to react to changes in contaminants in the water, including secondary contaminants that take the form of carbon dioxide, oxygen, hydrogen sulfide or arsenic.

### BRIEF DESCRIPTION OF THE DRAWING

The drawing, which are not necessarily drawn to scale, includes the following Figures:

FIG. 1 shows a graph of redox potentials in natural water in relation to E_{H} [mV], including seven redox couples at a pH of 8 labeled a1, a2, a3, . . . , a7 and redox couples at a pH of 7 labeled b1, b2, b3, . . . , b7 that is known in the art. The graph includes redox potential of some important redox couples in natural water at pH 7 (dark arrows) and pH 8 (light arrows). The redox potential is calculated for activities {Red}=1 and {OX}=1; in the case of Mn and Fe, {Mn²⁺}=1×10⁻⁶ M and {Fe²⁺}=1×10⁻⁶M are assumed. (Image taken from Sigg, 2000.)

FIG. 2 shows a graph of E_{H} (Volts vs. SHE) versus Chlorine (mg/L) showing the effects of Chlorine dosage on ORP, including six plots for electrodes 1 and 2 at a pH of 7, 8 and 9, that is known in the art. (Image from: Copeland Relationships Between Oxidation-Reduction Potentia, and pH in Drinking Water© 2004, American Water Works Association.)

FIG. 3 shows a graph of pH versus ORP (mV), e.g., of PPM of free Chlorine, that is known in the art. (Image from: Van London Pheonix Co. The Chemistry of Chlorine © 2012, Van London-pHoenix Company.)

FIG. 4 shows four graphs, each having four respective plots for Fe⁰=0 g/L, Fe⁰=1 g/L, Fe⁰=2 g/L and Fe⁰=4 g/L, showing the effects of iron dosage on ORP, pH and DO, including FIG. 4(a) showing a graph of pH versus time (min.); FIG. 4(b) showing a graph of DO (mg/L) versus time (min.); FIG. 4(c) showing a graph of ORP (mV) versus time (min.); and FIG. 4(d) showing a graph of Fe²⁺ (mg/L) versus time (min.), that are all known in the art. FIG. 4 shows the effect of an Fe⁰ dosage on an aqueous solution, including that shown in FIG. 4(a) pH, FIG. 4 (b) DO, FIG. 4 (c) ORP, and FIG. 4 (d) Fe²⁺ accumulation in the Fe⁰/CO₂ system. The CO₂ bubbling rate=200 mL/min; internal water recirculated flow=1000 mL/min. (Water Research)

FIG. 5 shows a graph of ORP (mV) versus pH in the form of a pH-ORP phase diagram fora selection of water types, e.g., lake, stream water, normal ocean water, swamp water, eutropic water, organic rich waterlogged soils and organic rich saline water. See pH-ORP phase diagram for a selection of water types. Langmuir, D. (1997). Aqueous Environmental Chemistry. New Jersey, Prentice-Hall, Inc. Image from: Tim Apps PhD What do you water test results mean?

FIG. 6 is a block diagram of apparatus in the form of a self contained, automatic water quality monitoring and treatment system, according to some embodiments of the present invention.

FIG. 6A is a block diagram of apparatus featuring a signal processor or processing module for implementing the signal processing functionality, according to some embodiments of the present invention.

FIG. 7 is a block diagram of a basic product configuration, including a main component (WQICM), a first modular component (e.g., an output module) and a second modular component (e.g., a signal response module), for implementing, and in accordance with, some embodiments of the present invention.

### DETAILED DESCRIPTION OF THE INVENTION

### Summary

In summary, the present invention uses ORP and pH sensors to monitor general water quality of primary and secondary contaminants continuously. By measuring trends in oxidative and reductive properties of water, as well as pH, it is possible to determine when water quality has been compromised. This cost effective alternative does not require a number of dedicated probes to determine each contaminant level. Other than Nitrates, it is shown that each primary contaminant listed below will have effect on the ORP of the water or the pH.

### Introduction

The present invention provides a new and unique technique that allows for the feasibility of using an ORP and pH combination monitor/controller as a cost effective device for monitoring and adjusting residential water quality. The technique provides a user with general feedback of its system's water quality. The technique also provides in line monitoring of ORP and pH in real time and include an alarm/control system that is triggered when the value varies outside a user determined set point, by way of example. Finally, the technique will offer generalized feedback on a variety of contaminants to reduce complexity and capital cost.

### Range of Contaminants

The technique may be configured to allow for a reaction to changes in contaminants of the following types:

### Primary Contaminants:

Iron (Ferric and Ferrous)
Alkaline and Acid Reactives (pH)
Chlorine
Nitrates

### Secondary Contaminants:

Carbon Dioxide
Oxygen
Hydrogen Sulfide
Arsenic

These contaminants are understood to be selected based on the severity of threat they pose to human health and infrastructure as well as common listings reported by the Water Systems Council. The technique is understood to be configured to react to changes in all primary contaminants. In contrast, the monitoring of secondary contaminants, which are not deemed to be absolutely necessary, may be added to the implementation (and underlying success) of the technique if a response may be found.

### Oxidation Reduction Potential and pH Theory

As a person skilled in the art would appreciate, the present invention is based upon an understanding of oxidation reduction potential (ORP) and pH theory, consistent with that which follows:

In order to measure the general quality of water, it is understood that ORP must be measured with pH due to their heavy dependence with one another. pH is the logarithmic measure of hydrogen ion (H⁺) concentration within a solution. This means that lower pH levels mean high H⁺ concentrations, indicating that the solution is more acidic. In contrast, higher pH values indicates high levels of hydroxide concentration (OH⁻), or a more basic solution. In most drinking water applications, the standard for pH ranges is understood to be from 6.5 to 8.5.

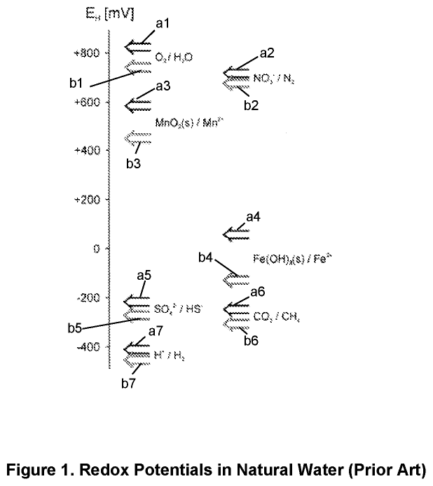

Oxidation Reduction Potential (ORP) is the potential for the solution to either oxidize or reduce. ORP is measured in millivolts (mV) based on the standard electrode potential, typically to platinum. If the returned value is positive, this is indicative of an oxidizing agent. If the ORP returns negative, this indicates that the water exhibits the characteristics of a reducing agent. It should be seen that pH will have an inverse effect on the outcome of ORP. With decreased pH, ORP will increase and with increased pH, ORP will decrease. Therefore, pH and ORP will need to be measured simultaneously in order to overcome measurement errors due to this dependence. A recommended range for ORP is +100 to +400 mV. This range is determined based on the thermodynamic properties of common chemical couples to react in water at a pH of 7. FIG. 1 shows a graph of redox potentials in natural water, which shows this visually.

As indicated by FIG. 1, higher ORP values indicate the potential for high levels of corrosive O₂, Nitrate conversion to Nitrogen gas and other aerobic processes. Lower ORP values indicate the potential for water to contain soluble Ferrous Iron, Ammonium and hydrogen sulfide production from sulfates. It is important to note that the results shown in FIG. 1 are influenced by pH, indicating the changes in ORP values with a measured pH value of 8 and 7. This strengthens the need to simultaneously record pH with ORP.

Additionally, Chlorine directly affects ORP levels indicating the ability to monitor chlorine contamination:

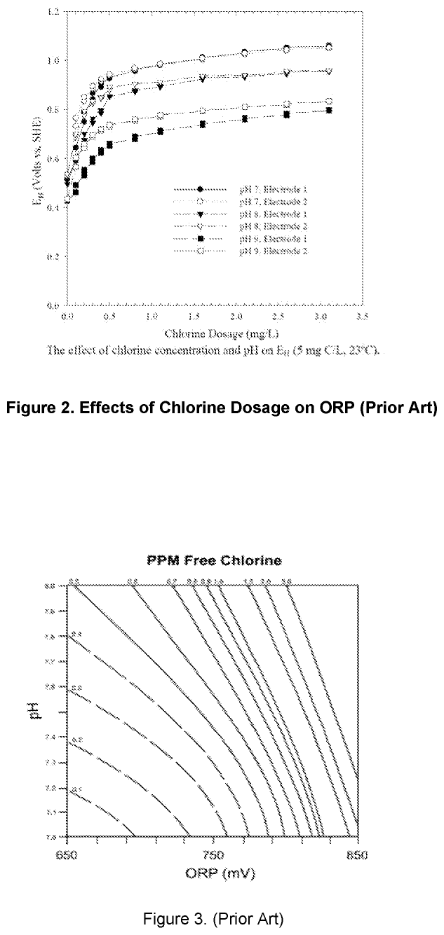

According to the EPA, drinking water standards for chlorine should not exceed 0.8 mg/L. FIG. 2 shows a graph that indicates a heavy dependence on Chlorine dosage until approximately 0.6 mg/L. Chlorine introduction will additionally affect pH levels, and it is therefore important to note that the ORP trend does not vary with adjusted pH, but rather shifts the resulting trend up or down. This dependence indicates that an ORP sensor will react to changes in Chlorine (exceeding 400 mV ORP at unsafe levels), or indicate the potential for preexisting Chlorine.

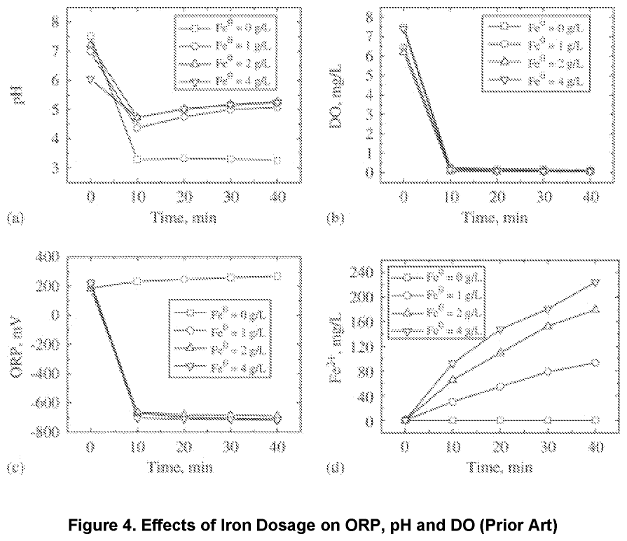

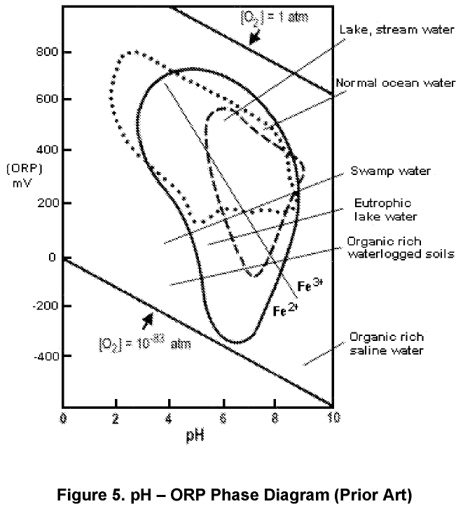

Additionally, Chlorine can be generally monitored using pH and ORP using the graph shown in FIG. 3. This graph offers a general concentration of free chlorine by matching the ORP and pH values, if chlorine is determined to be the cause for water contamination. This graph may also serve as a way of determining chlorine levels for those wishing to treat their water with chlorine.

In terms of Iron, the following was determined when Iron (Fe⁰) was dosed into an aqueous solution. The following results indicate the effects Ferrous iron (Fe²⁺) will have on ORP, pH and DO (Water Research)

It should be noted that CO₂ was additionally introduced into this system. Based on the results for 0 g/L Fe⁰, it can be observed that CO₂ bubbling caused dramatic changes to pH and very little to no influence on system ORP. Therefore, the dramatic changes in ORP found in FIG. 3 when iron was introduced must be contributed to increase in Ferrous Iron concentrations (Reducing Agent). This indicates that soluble ferrous iron would be recognizable by an ORP sensor in a well water scenario.

For cases where insoluble Ferric Iron may be present, either from well water or pipe corrosion, ORP and pH sensors would not be able to directly indicate levels of concentration. In this case, water would turn brown from the tap offering a sufficient visual indication. On the other hand, ORP and pH can be used as a potential indicator of corrosion favored water quality. In cases where ORP is high (above 500 mV) and pH low (below 6.5), it is very likely that iron material in the water system could corrode at a high rate causing an increase in ferric iron concentration.

With regard to Nitrates: Nitrates are a part of the Nitrogen cycle and therefore can be determined whether the potential for Nitrates may be present by low ORP values indicating Ammonia or Nitrites. This is more difficult to monitor being that Nitrates are often formed at ORP's greater than 0 mV. Research into this trend is needed

Other secondary contaminants listed above are found to have the following effects:
Carbon Dioxide—Decreasing pH,
Oxygen (O₂) or Ozone (O₃)—Increasing ORP,
Hydrogen Sulfide—Very Negative ORP, and
Arsenic—Dissolved Solid, Effects on ORP and pH unknown.

### Oxidation Reduction Potential and pH Application

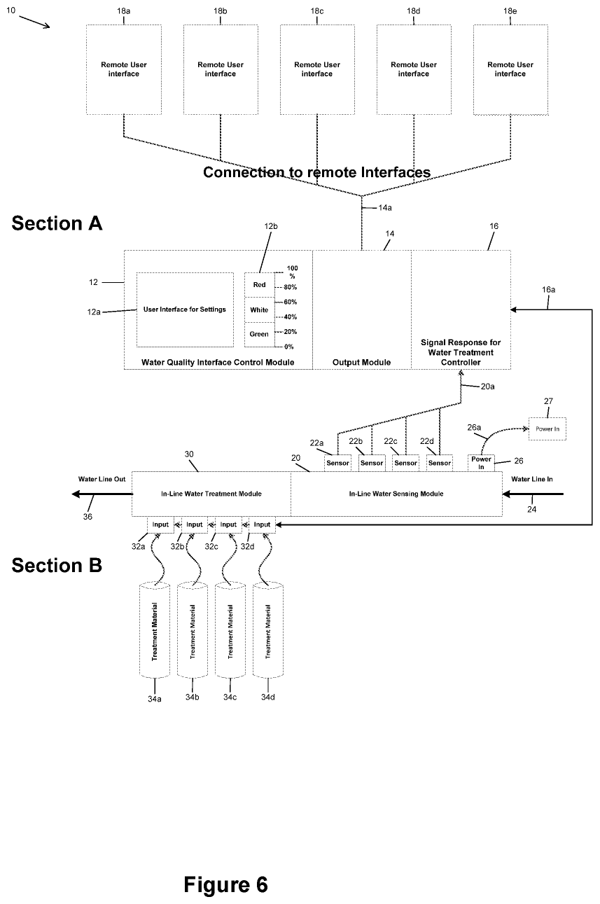

Major chemical and biological processes found to have a significant effect on overall water quality have also been found to have an effect on system pH and ORP. FIG. 5 shows a graph in the form of an ORP phase diagram, which provides a general understanding of water quality using ORP and pH that can be determined:

Since recommended ranges for drinking water reach from 6.5 to 7.5 pH and +100 to +400 mV for ORP, the area representing ideal drinking water quality is represented by the long dashed region. A line has been included to indicate the exchange from soluble ferrous iron (Fe²⁺) and insoluble ferric iron (Fe³⁺) (Tim Apps). Indicators of approximate oxygen levels are also included.

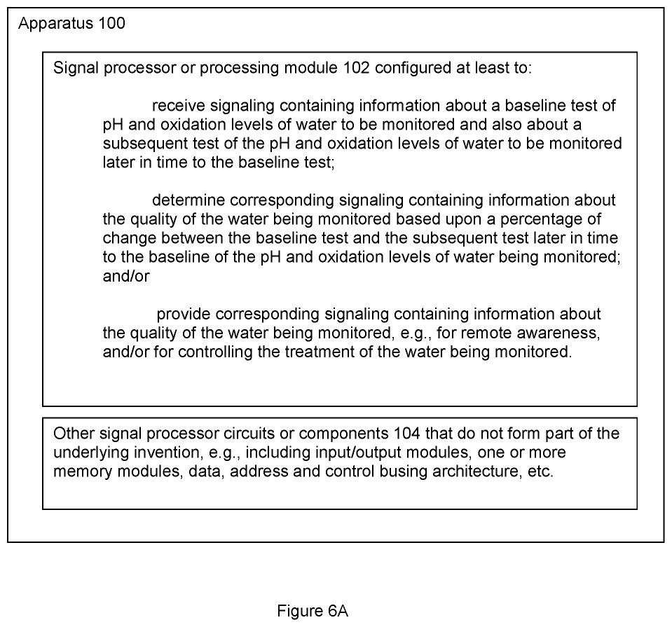

### FIG. 6: The Main Concept

In particular, FIG. 6 shows an example of a self contained, automatic water quality monitoring and treatment system generally indicated as 10, according to some embodiments of the present invention. The self contained, automatic water quality monitoring and treatment system 10 may include a water quality interface control module (WQICM) 12, an output module 14, a signal response for water treatment controller 16, remote interfaces 18a, 18b, 18c, 18d, 18e, an in-line water sensing module 20 and an in-line water treatment module 30.

The self contained, automatic water quality monitoring and treatment system 10 may be configured to operate, as follows:

The in-line sensors 22a, 22b, 22c, 22d may be configured to sense the pH and oxidation (e.g., ORP) levels of water to be monitored, and provide sensed signaling containing information about the pH and oxidation levels of water to be monitored. The sensed signaling may be provided along line 20a to the signal response for water treatment controller 16. In-line sensors like elements 22a, 22b, 22c, 22d for sensing and providing associated signaling containing information about the associated sensing are known in the art, and the scope of the invention is not intended to be limited to any particular type or kind of in-line sensor either now known or later developed in the future.

The water quality interface control module 12 may include a user interface 12a for receiving settings by a user and also include a display 12b for providing visual information about the quality of the water being monitored. By way of example, the user interface 12a may include, or take the form of, a touch-based keypad. The water quality interface control module 12 may also include a signal processor or processing module, e.g., including element 102 in FIG. 6A, configured to receive the sensed signaling containing information about a baseline test of pH and oxidation (e.g. ORP) levels of water to be monitored and also about a subsequent test of the pH and oxidation levels of water to be monitored later in time to the baseline test. By way of example, the baseline test of pH and oxidation levels of water to be monitored may be based upon lab tested water, e.g., by a 3rd party water tester, or may be implemented during installation of the system 10, e.g., by the in-line water sensing module 20. The information related to the baseline test may be stored on a suitable memory module that forms part of the WQICM 12, e.g., see element 104 (FIG. 6A). The subsequent test of the pH and oxidation levels of water to be monitored later in time to the baseline test may be implemented, e.g., by the in-line water sensing module 20, at some time later than or after the baseline test. The scheduling of subsequent test may be automatic or predefined by the user, and e.g., may be scheduled hourly, daily, weekly, monthly, quarterly, biannually, yearly from the date of the baseline test. The scope of the invention is not intended to be limited to the scheduling or time period between the baseline test and the subsequent test, nor the frequency of subsequent testing in relation to the baseline test.

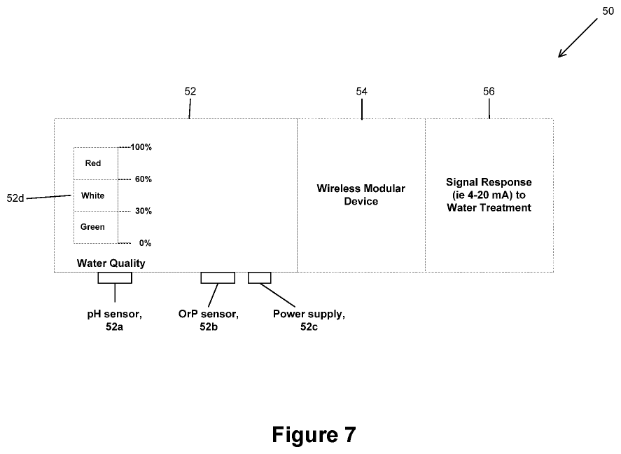

The signal processor like element 102 (FIG. 6A) may be configured to determine the quality of the water being monitored based upon a percentage of change between the baseline test and the subsequent test later in time to the baseline of the pH and oxidation levels of water being monitored. The percentage of change is understood to be a rate of change, in contrast to a discrete level or reading. By way of example, and consistent with that set forth below in relation to FIG. 7 below, the percentage of change between the baseline test and the subsequent test may include a first range of percentage of change, e.g., is below 30% or between 0% and 30%, which may be understood or defined to be a good rate of change; may include a second range of percentage of change, e.g., between 30% and 60%, which may be understood or defined to be an intermediate change (e.g., not as good but not so bad); and may include a third range of percentage of change, e.g., is above 60″ or between 60% and 100%, which may be understood or defined to be a bad rate of change. The range and/or percentage of change may be defined by the user, and may include, e.g. two or more ranges of two or more percentages of change. The scope of the invention is not intended to be limited to either the range of percentage of change, or the number of ranges, or the number of percentages of changes, or the percentages of any particular changes. For example, embodiments are envisioned, and the scope of the invention is intended to include, using two ranges of percentages of changes such as above and below 50%. In this case, the range of 0% to 50% is an OK rate of change, while a range of 50% to 100% is not an OK rate of change. Alternatively, the ranges may include 0% to 30% (OK change) and 30% to 100% (not OK change); or 0% to 15% (OK change) and 15% to 100% (not OK change). Further, embodiments are envisioned, and the scope of the invention is intended to include, using three ranges of percentages of changes such as 0% to 33% (OK change), 33% to 66% (less OK change) and 66% to 100% (not OK change); or such as 0% to 15% (OK change), 15% to 50% (less OK change) and 50% to 100% (not OK change); etc. The user interface 12a for receiving settings may be manually or remotely programmed by the user (e.g., including remotely via a wireless interface, as described below) to set the ranges and/or percentages of changes to be monitored, e.g., similar to a thermostat is programmed by a home owner to determine the day, time and temperature settings for weekdays and/or the weekend for heating a home, a business environment, etc.

The signal processor like element 102 (FIG. 6A) may be configured to provide corresponding signaling containing information about the quality of the water being monitored, e.g., to be displayed on the display 12b that forms part of the WCICM 12. By way of example, and consistent with that set forth below in relation to FIG. 7 below, the ranges of percentages of change between the baseline test and the subsequent test may be displayed using a green, white and red indication scheme, as shown in FIG. 6, the coloration of which corresponds to respective ranges of corresponding percentages of change. In FIG. 6A, the signal processor like element 102 (FIG. 6A) is disclosed forming part of an apparatus 100, e.g., that may include, or take the form of, the self contained, automatic water quality monitoring and treatment system 10, consistent with that set forth herein.

The corresponding signaling may also contain information for treating the water being monitored, e.g., by providing or including treatment signaling along line 16a, consistent with that described below. For example, the in-line water treatment module 30 may be configured to receive the water and may include one or more in-line water treatment inputs 32a, 32b, 32c, 32d, 32e. Each in-line water treatment inputs 32a, 32b, 32c, 32d, 32e may be configured to receive the treatment signaling, e.g., along line 16a, that forms at least part the corresponding signaling, and may also be configured to provide one or more treatment materials 34a, 34b, 34c, 34d to change the quality of water being monitored, including where the treatment material 34a, 34b, 34c, 34d changes the pH and oxidation levels of water being monitored. Consistent with that set forth herein, the treatment material 34a, 34b, 34c, 34d may include materials for treating some combination of the primary and/or secondary contaminants, e.g., consistent with that set forth herein. The scope of the invention is not intended to be limited to any particular type or kind of the treatment material, and may include treatment materials that are both now known and later developed in the future. Moreover, in-line water treatment inputs or input modules, like elements 32a, 32b, 32c, 32d, 32e, are known in the art, and the scope of the invention is not intended to be limited to any particular type or kind thereof that is now known or later developed in the future.

The one or more remote user interfaces or display units 18a, 18b, 18c, 18d, 18e may be configured to receive remote user interface signaling, e.g., along line 14a, that forms at least part of the corresponding signaling. The one or more remote user interfaces or display units 18a, 18b, 18c, 18d, 18e may also include a display (e.g., like element 12b (FIG. 6)) configured to display information about the water quality being monitored, e.g., including the ranges and/or percentages of change between the baseline test and the subsequent test as set forth herein, as well as including a visual rate of percentage change versus (or instead of) a discrete measurement, based upon the corresponding signaling received. By way of example, each of the one or more remote user interfaces or display units 18a, 18b, 18c, 18d, 1 may include a corresponding signal processor or signal processing architecture for implementing the associated signal processing functionality, e.g., consistent with the signal processer 102 (FIG. 6A). In a building implementation according to some embodiments of the present invention, each remote user interface or display unit 18a, 18b, 18c, 18d, 18e may be arranged on a separate floor of the building, or a separate floor location on a floor of the building. In contrast, in a complex of buildings according to some embodiments of the present invention, each remote user interface or display unit 18a, 18b, 18c, 18d, 18e may be arranged in a separate building.

Embodiments are also envisioned in which a smart phone, a tablet, a desktop, a laptop, etc. may be configured with an app or application for remotely implementing the functionality of interfacing with the combination of elements 12, 14, 16, as well as the remote user interface or display units 18a, 18b, 18c, 18d, 18e, e.g., for monitoring the water from a remote location using such a smart phone, a tablet, a desktop, a laptop, etc. Embodiments are also envisioned in which the app or applications may be configured to allow such a smart phone, a tablet, a desktop, a laptop to provide suitable signaling to control, adapt, modify or program the combination of elements 12, 14, 16, e.g., to change/modify the user interface settings, or to provide suitable treatment signaling to the in-line water treatment module 30 along line 16a to implement a desired treatment to the water being monitored, etc. In other words, embodiments are envisioned within the combination of elements 12, 14, 16, the remote user interface or display units 18a, 18b, 18c, 18d, 18e, the inline water sensing module 20 and/or the in-line water treatment module 30 may be remotely controlled using such a smart phone, a tablet, a desktop, a laptop, etc. via such an app or application within the spirit of the underlying invention.

The scope of the invention is intended to include providing the respective signaling along lines 14a, or 16a, or 20a, as hard line signaling, as well as wireless remote (e.g., Bluetooth), Internet or WIFI signaling, e.g., using wireless signal protocols that are now known and later developed in the future.

Consistent with that shown in FIG. 6, the in-line water sensing module 20 may be configured with associated power-in modules 26, 27 coupled together by a respective power in line 26a for implementing power in related functionality associated with the in-line water sensing module 20, e.g., including providing power to/from the in-line water sensing module 20, as well as providing information about the power being provided to/from the in-line water sensing module 20.

### FIG. 7: The Basic Product Configuration

FIG. 7 shows a basic product configuration generally indicated as 50, including a main component 52, a first modular component 54 and a second modular component 56. The basic product configuration 50 would operate consistent with the combination of elements 12, 14 and 16 in FIG. 6, according to some embodiment of the present invention.

The main component 52 may include a pH sensor module 52a, an ORP sensor module 52b, a power supply module 52c, and a response LED module 52d. In operation, the response LED 52d may be configured to indicate the range and/or percentage of change between the baseline test and the subsequent test of the pH and oxidation levels of water being monitored, e.g., showing the color “green” when the percentage of change is between 0% and 30%, showing the color “white” when the percentage of change is between 30% and 60%, and showing the color “red” when the percentage of change is between 60% and 100%.

The first modular component 54 may be configured as a wireless device, pack or hardware/software circuit for responding to associated signaling received from the main component 52, and for providing corresponding wireless signaling containing information about the quality of the water being monitored based upon a percentage of change between the baseline test and the subsequent test later in time to the baseline of the pH and oxidation levels of water being monitored. By way of example, the wireless signaling may be received by the one or more remote user interfaces 18a, 18b, 18c, 18d and 18e shown in FIG. 6.

The second modular component 56 may be also configured for responding to other associated signaling received from the main component 52 and for providing a signal response (e.g., in the range of 4-20 mA) to a water treatment module. The signal response may include, or take the form of, an output signal to such a water treatment module. By way of example, the output signal may be received by the in-line water treatment module 30 in FIG. 6.

The pH sensor module 52a and the ORP sensor module 52b may be configured to implement the sensing and associated signal processing related to the pH and ORP sensing functionality, e.g., consistent with that set forth herein.

In summary, and by way of example, the basic product configuration 50 in FIG. 7 may be implemented as follows:

### Measure: pH Vs. ORP

By way of example, the pH vs. ORP may be measured, as follows:
Create baseline water test (3^{rd} party) at initial installation of device, e.g., using the main component 52;
Test results to define initial water quality acceptance, water treatment may be needed; and
Installation of the pH sensor 52a and the ORP sensor 52b to capture the water measurements and provide the signal processing associated with the same.

### Response of System

By way of example, the response of the system may include the following:

In operation, the pH vs. ORP would measure change (delta), which may be used consistent with the following:
Response to relative percentage of change (i.e. bar graph); this differs from the prior art commercially available devices in which the user would be required to define limits;
Response to change would also signal “water treatment” device to increase/decrease treatment, e.g., using the second modular component 56.
   This would meter the water treatment of “poor” water quality in terms of actual need instead of consistent treatment which may lead to overtreatment or under treatment.
   The Environment Protection Agency (EPA) suggests to test water every year for total coliform bacteria, nitrates, total dissolved solids and pH levels, especially if one has a new well, or have replaced or repaired pipes, pumps or the well casing.
Typical Water Quality Occurrences: Table 1 below shows typical water quality occurrences, as follows:

TABLE 1

| | | pH/ |
|---|---|---|
| Conditions or nearby activities | Recommended Test | ORP |
| Recurrent gastro-intestinal illiness | Coliform bacteria | X |
| Household plumbing contains lead | pH, lead, copper | X |
| Radon in indoor air or region os | Radon | |
| radon rich | | |
| Scaly residues, soaps don't lather | Hardness | |
| Water softner needed to treat hardness | Manganese, Iron | |
| Objectionable taste or smell | Hydrogen sulfide, | X |
| | corrision, metals | |
| Nearby areas of intensive agriculture | Nitrate, pesticides, | X |
| | coliform bateria | |
| Gas drilling operatin nearby | Chloride, sodium, | X |
| | barium, strontium | |
| Odor of gasoline or fuel oil, and near | Volatile organic | X |
| gas station or buried fuel tanks | compounds (VOC) | |
| Dump, junkyard, landfill, factory or | VOC, Total disolved | X |
| dry-cleaning operation nearby | solids (TDS), pH, | |
| | sulfate, chloride, metals | |
| Salty tast and seawater, or a heavily | Chloride, TDS, sodium | X |
| salted roadway nearby | | |

Response of water quality “change” could also be accessible via web application; wireless signal integrated into measuring device, e.g., via the first modular component 54.

### Application

By way of example, applications may include water quality awareness for domestic or commercial water supplies.

### Implementation of the Functionality of the Signal Processor or Processing Module

The functionality of the aforementioned modules or interfaces may be implemented in whole or in part using one or more signal processor or processing modules that may be configured using hardware, software, firmware, or a combination thereof, although the scope of the invention is not intended to be limited to any particular embodiment thereof. In a typical software implementation, a signal processor or processing module, e.g., like element 102 (FIG. 6A), may take the form of one or more microprocessor-based architectures having a processor or microprocessor, a random access memory (RAM), a read only memory (ROM), where the RAM and ROM together form at least part of a memory for storing a computer program code, input/output devices and control, data and address buses connecting the same. A person skilled in the art would be able to program such a microprocessor-based implementation with the computer program code to perform the functionality described herein without undue experimentation. The scope of the invention is not intended to be limited to any particular implementation using technology either now known or later developed in the future. Moreover, the scope of the invention is intended to include the signal processor or processing module being a stand alone module, or in some combination with other circuitry for implementing another module. Moreover still, the scope of the invention is not intended to be limited to any particular type or kind of signal processor or processing module used to perform the signal processing functionality, or the manner in which the computer program code is programmed or implemented in order to make the signal processor operate.

The signal processor or processing module, e.g., like element 102 (FIG. 6A), may include one or more other sub-modules for implementing other functionality that is known in the art, but does not form part of the underlying invention per se, and is not described in detail herein. For example, the functionality of the one or more other modules may include the techniques for the receiving signaling, provisioning of signaling for activating, deactivating or controlling the pump based on certain processing control functionality, including providing the signal automatically, providing the signal after a certain time period, etc., that can depend on a particular application for a particular customer.

The signal processor or processing module may also be configured to implement the underlying signal processing functionality in combination with other signal processor circuits or components 104 (FIG. 6A), e.g., including input/output modules, memory modules, data, address and control busing architecture, etc.

### Applications

Applications for the present invention are broadly understood to include water treatment, including:
Drinking water,
Well water,
Aquariums,
Dosing and
Agricultural.

The scope of the invention is not intended to any particular type or kind of applications; and embodiments are envisioned, and the scope of the invention is intended to include, other types or kinds of application that are either now known or later developed in the future.

### Recommendations

Some recommendations for determining project feasibility are:
Test Device for effects with Nitrates
Long Term Testing for continual accuracy and cleaning requirements
Locate “In-Line” probe for continuous monitoring and easy system connection
Test device in high levels of Hydrogen Sulfide to test Platinum related issues
Test probes in abrasive environments (Ferric Iron, Sand)
Develop a trend report to analyze contaminant effects on ORP/pH and water quality

### The Scope of the Invention

Further still, the embodiments shown and described in detail herein are provided by way of example only; and the scope of the invention is not intended to be limited to the particular configurations, dimensionalities, and/or design details of these parts or elements included herein. In other words, a person skilled in the art would appreciate that design changes to these embodiments may be made and such that the resulting embodiments would be different than the embodiments disclosed herein, but would still be within the overall spirit of the present invention.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

1-20. (canceled)

21. A water quality monitoring and treatment system, comprising:
an in-line sensing module having in-line sensors that:
sense simultaneously baseline pH and oxidation levels of water being monitored,
sense simultaneously subsequent pH and oxidation levels of the water being monitored later in time to the sensing of the baseline pH and oxidation levels, and
provide sensed signaling containing information about the baseline pH and oxidation levels and the subsequent pH and oxidation levels; and
a water quality interface control module having a user interface, a signal processor and an in-line water treatment module,
the user interface configured to receive at least on user setting set by a user containing information about a pre-set percentage of change or rate of change between the baseline pH and oxidation levels and the subsequent pH and oxidation levels in order to monitor the quality of the water, and provide user setting signaling containing information about the pre-set percentage of change or rate of change,
the signal processor configured to:
receives the user setting signaling and the sensed signaling, and
determines corresponding signaling containing information about contaminants other than pH and oxidation levels that affect the quality of the water being monitored based upon the pre-set percentage of change set by the user and the baseline pH and oxidation levels and the subsequent pH and oxidation levels sensed by the in-line sensors, and also based upon the user setting signaling and the sensed signaling received, and
the in-line water treatment module configured to receives the water being monitored, the in-line water treatment module having one or more treatment input control modules that receives the corresponding signaling in the form of treatment signaling, and provides treatment material to the in-line water treatment module to change the quality of water.

22. A water quality monitoring and treatment system, according to claim 21, wherein the signal processor provides the corresponding signaling for remote awareness, including via wireless signaling, either for displaying on a remote user interface, or controlling the treatment of the water being monitored, or both.

23. A water quality monitoring and treatment system, according to claim 21, wherein the baseline water test is based upon lab tested water, or conducted at an initial installation.

24. A water quality monitoring and treatment system, according to claim 21, wherein the signal processor makes the determination at a pre-set rate, including where the pre-set rate is either a user-defined pre-set rate or is a factory pre-set rate.

25. A water quality monitoring and treatment system, according to claim 21, wherein the water quality monitoring and treatment system comprises an awareness-based “percentage of change” unit having the signal processor in combination with a display configured to provide a visual rate of percentage change indication versus a discrete measurement, or an alert module for providing an audio or visual alert based upon an alert setting, or both the display and the alert module.

26. A water quality monitoring and treatment system, according to claim 22, wherein the wireless signaling is for providing mobile or Internet awareness.

27. A water quality monitoring and treatment system, according to claim 21, wherein the water quality monitoring and treatment system comprises one or more remote user interfaces or display units having a corresponding signal processor in combination with a display, including where the corresponding signal processor receives the corresponding signaling, and the display provides a visual rate of percentage change indication versus a discrete measurement, based upon the corresponding signaling received.

28. A water quality monitoring and treatment system, according to claim 21, wherein the water quality monitoring and treatment system comprises a signal response module for a water treatment controller, and the sensed signaling is provided to the signal response module.

29. A water quality monitoring and treatment system, according to claim 21, wherein the treatment material changes the pH and oxidation levels of water by adjusting the chlorination or softness of the water being monitored.

30. A water quality monitoring and treatment system according to claim 21, wherein the contaminants include primary contaminants selected from a group comprising one or more of the following: iron, alkaline or acid reactives (pH), chlorine and nitrates.

31. A water quality monitoring and treatment system according to claim 30, wherein the contaminants include secondary contaminants selected from another group comprising one or more of the following: carbon dioxide, oxygen, hydrogen sulfide and arsenic.

32. A water quality monitoring and treatment system according to claim 21, wherein the water is drinking water, well water or aquarium water.

33. A self contained, automatic water quality monitoring and treatment system, comprising:
an in-line sensing module having in-line sensors that:
sense simultaneously baseline pH and oxygen reduction potential (ORP) levels of water being monitored, and
sense simultaneously subsequent pH and oxygen reduction potential (ORP) levels of water being monitored later in time to the sensing of the baseline pH and oxidation levels, and
provide sensed signaling containing information about the baseline pH and ORP levels and the subsequent pH and ORP levels;
a water quality interface control module having a signal processor that:
receives the sensed signaling,
determines corresponding signaling containing information about contaminants other than pH and ORP levels that affect the quality of the water being monitored based upon a rate of percentage of change between the baseline pH and ORP levels and the subsequent pH and ORP levels, and also based upon the sensed signaling received, and
provides the corresponding signaling containing information about contaminants that affect the quality of the water being monitored, or for controlling treatment of the water being monitored, or both;
an in-line water treatment module that receives the water, having one or more in-line water treatment inputs that receives treatment signaling that forms at least part the corresponding signaling, and provides one or more treatment materials to change the quality of water, including where the treatment material changes the pH and ORP levels of water; and
one or more remote user interfaces or display units that receives remote user interface signaling that forms part of the corresponding signaling, and having a display that provides a visual rate of percentage change indication versus a discrete measurement, based upon the remote user interface signaling received.

34. A self contained, automatic water quality monitoring and treatment system according to claim 33, wherein the signal processor provides the corresponding signaling for remote awareness, including via wireless signaling, either for displaying on a remote user interface, or controlling the treatment of the water being monitored, or both.

35. A self contained, automatic water quality monitoring and treatment system according to claim 33, wherein the baseline test is based upon lab tested water, or conducted at an initial installation.

36. A self contained, automatic water quality monitoring and treatment system according to claim 33, wherein the signal processor makes the determination at a pre-set rate, including where the pre-set rate is either a user-defined pre-set rate or is a factory pre-set rate.

37. A self contained, automatic water quality monitoring and treatment system according to claim 33, wherein the water quality interface control module comprises a display that provides a visual rate of percentage change indication versus a discrete measurement that contains information about the quality of the water being monitored, or an alert module for providing an audio or visual alert based upon an alert setting, or both the display and the alert module.

38. A self contained, automatic water quality monitoring and treatment system according to claim 33, wherein the contaminants include primary contaminants selected from a group comprising one or more of the following: iron, alkaline or acid reactives (pH), chlorine and nitrates.

39. A self contained, automatic water quality monitoring and treatment system according to claim 38, wherein the contaminants include secondary contaminants selected from another group comprising one or more of the following: carbon dioxide, oxygen, hydrogen sulfide and arsenic.

40. A self contained, automatic water quality monitoring and treatment system according to claim 33, wherein the water is drinking water, well water or aquarium water.
